(19) United States
(12) Patent Application Publication
(10) Pub. No.: US 2004/0095744 A1
(43) Pub. Date: May 20, 2004

(54) Backlight system and light guide plate used therein

(76) Inventors: Tai-Cheng Yu, Tu-chen (TW); Charles Leu, Fremont, CA (US); Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/639,072

(22) Filed: Aug. 11, 2003

(30) Foreign Application Priority Data
Nov. 15, 2002 (TW) 91218339

(51) Int. Cl. F21V 7/04

(52) U.S. Cl. 362/31

(57) ABSTRACT

A backlight system of the present invention includes a light guide plate (300) and a light source (310) disposed at one side of the light guide plate. The light guide plate has an incident surface (321) for receiving light from the light source, a bottom surface (323), and a light emitting surface (322) for emitting light therethrough. A plurality of prisms (350), each in a shape of a pyramid, are formed on the light emitting surface. A plurality of diffusion dots (324) are formed on the bottom surface.

### BACKGROUND OF THE INVENTION

1. Field of the Invention

The present invention relates to a backlight system used for a liquid crystal display (LCD), and particularly to a light guide plate used therein. This application relates to a contemporaneously filed application having the same title, the same applicants and the same assignee with the instant application.

2. Description of Related Art

A conventional backlight system 100 popular today is shown in FIG. 6.

In FIG. 6, a light guide plate 120 is made of a transparent material, such as a synthetic resin. The light guide plate 120 includes an incident surface 121, a light emitting surface 122 and a back surface 123 opposite to and inclined to the emitting surface 122. Thus, the light guide plate 120 has a wedge shape in cross section. A light source 110 using a thin tube fluorescent lamp is adjacent to the incident surface 121 of the light guide plate 120. A light diffusing film 130 is used to further diffuse the outgoing light from the light emitting surface 122. A prism film 140 has a lower prism film 141 and an upper prism film 142. The prism film 140 serves to redirect the diffused light from the light diffusing film 130 to be more parallel.

In operation, the light from the light source 110 is repeatedly reflected inside the light guide plate 120 and is emitted from the emitting surface 122 to enter the light diffusing film 130, and after that, the prism film 140. In the end, the light provided is uniform and relatively collimated and can be used to illuminate a liquid crystal panel. However, the backlight system is quite complicated, difficult to assemble, and is expensive to manufacture.

FIGS. 7 and 8 show another backlight system disclosed in U.S. Pat. No. 6,123,431, which comprises a light source 210 and a wedge-shaped light guide plate 220. The light guide plate 220 comprises an incident surface 221 receiving light from the light source 210, a light emitting surface 222, a side surface 230 opposite to the incident surface 221, and a bottom surface 223. Pyramid-shaped protrusions 250 are provided and disposed in parallel bands to form an array, the bands being spaced at different intervals, on the emitting surface 222. Each band of pyramid-shaped protrusions 250 is parallel to the light source 210. The interval between two adjacent bands 250 becomes smaller as a distance away from the incident surface 221 increases. However, to assure that light is uniformly emitted, the interval between each two adjacent bands of horizontal protrusions 250 must be calculated according to an irradiance distribution of the light emitted from the light emitting surface 222, which is difficult and complicated to put into practice.

It is desirable to provide a backlight system and a light guide plate used therein which overcomes the above problems.

### SUMMARY OF THE INVENTION

An object of the present invention is to provide a backlight system employing a light guide plate which enhances the brightness and uniformity of the outgoing light beams.

Another object of the present invention is to provide a backlight system which is easily manufactured at a low cost.

A backlight system of present invention comprises a light guide plate and a light source disposed at one side of the light guide plate.

The light guide plate is made of a transparent material such as a synthetic resin or a glass. The light guide plate comprises an incident surface for receiving light from the light source, a bottom surface, and a light emitting surface for emitting the light. A plurality of pyramid-shaped prisms are disposed continuously on the light emitting surface. A plurality of diffusion dots are formed on the bottom surface by a screen-printing method.

Because the pyramid-shaped prisms are formed evenly on the light emitting surface and the diffusion dots are deposited evenly on the bottom surface, the irradiance distribution of the outgoing light is uniform. The light guide plate is formed by an injection molding method and so it is easy to manufacture.

Other objects, advantages, and novel features of the present invention will become more apparent from the following detailed description when taken in conjunction with the accompanying drawings.

### BRIEF DESCRIPTION OF THE DRAWINGS

FIG. 1 is a perspective view of a backlight system according to the present invention;

FIG. 2 is a bottom view of the backlight system in FIG. 1;

FIG. 3 is a top view of the backlight system in FIG. 1;

FIG. 4 is a perspective view of an alternative embodiment of a backlight system according to the present invention;

FIG. 5 is a bottom view of the embodiment of FIG. 4;

FIG. 6 is a schematic view showing an exploded state of a conventional backlight system;

FIG. 7 is a perspective view showing another prior art backlight system; and

FIG. 8 is a top view of the backlight system in FIG. 7.

### DETAILED DESCRIPTION OF THE INVENTION

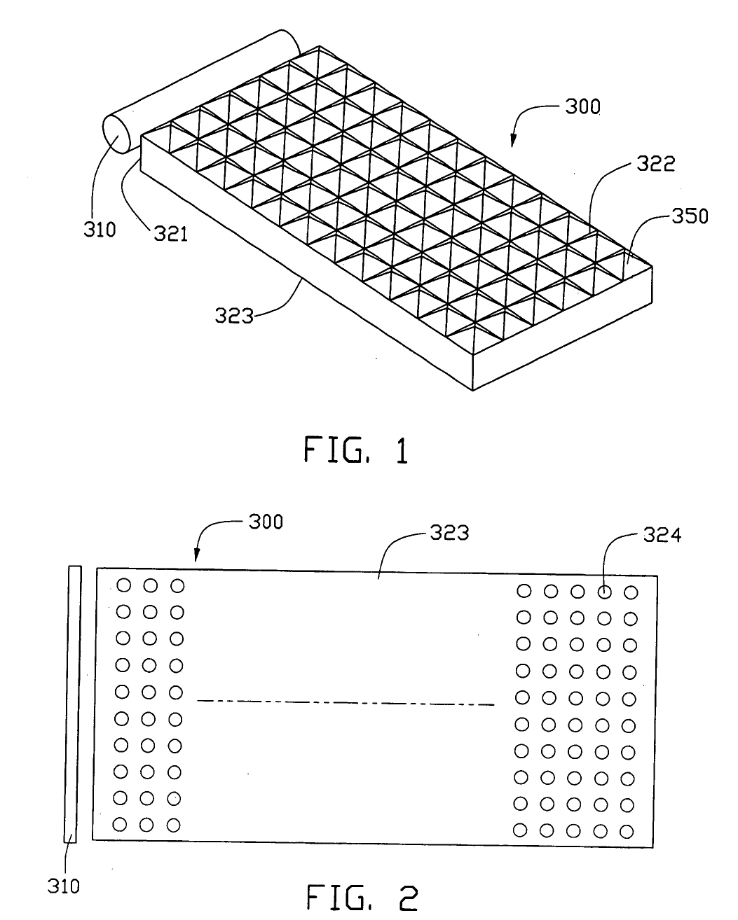

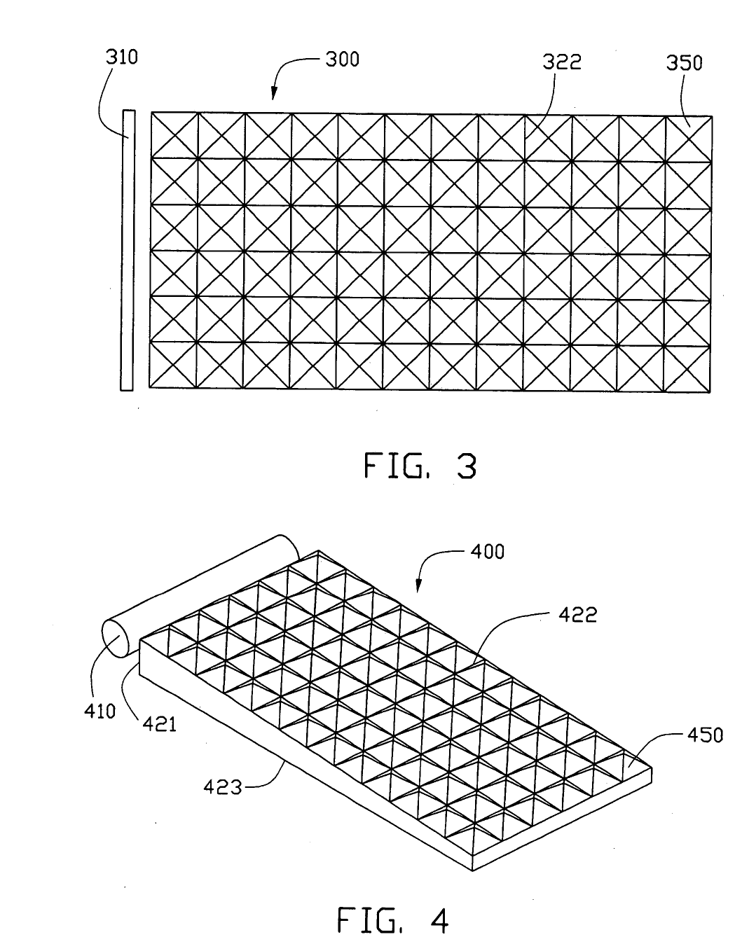

Referring to FIGS. 1, 2 and 3, a backlight system of the present invention comprises a light source 310 and a light guide plate 300 disposed at one side of the light source 310.

The light guide plate 300 is rectangular in shape and is made of a transparent material, such as a synthetic resin or a glass. The light guide plate 300 comprises an incident surface 321 for receiving light from the light source 310, a bottom surface 323, and a light emitting surface 322 for emitting the light, wherein the light emitting surface 322 has a contour in a shape of a plurality of prisms 350, each in a shape of a pyramid, disposed continuously on the light emitting surface 322 for converging the outgoing light to improve an illumination.

A plurality of diffusion dots 324 are formed on the bottom surface 323 by a screen-printing method for scattering the light. These diffusion dots 324 are distributed uniformly and scatter the incident light from the incident surface 321 so that the light is uniformly transmitted through the light emitting surface 322.

The pyramid-shaped prisms 350 are formed edge-to-edge on the light emitting surface 322 to converge the outgoing light emitted from the light emitting surface 322 in a predetermined angular range.

The light source 310 can be a cathode ray tube, such as a hot cathode ray tube or a cold cathode ray tube. A curved reflection plate (not shown) could be provided to enclose the light source 310 so as to efficiently utilize the light emitted by the light source 310.

In operation, the light emitted by the light source 310 propagates into the light guide plate 300 through the incident surface 321. Then, the light is totally internal reflected by the bottom surface 323 and is uniformly scattered by the diffusion dots 324 to the light emitting surface 322. When the light is emitted from the light emitting surface 322, it is directed in a predetermined angular range by the pyramid-shaped prisms 350.

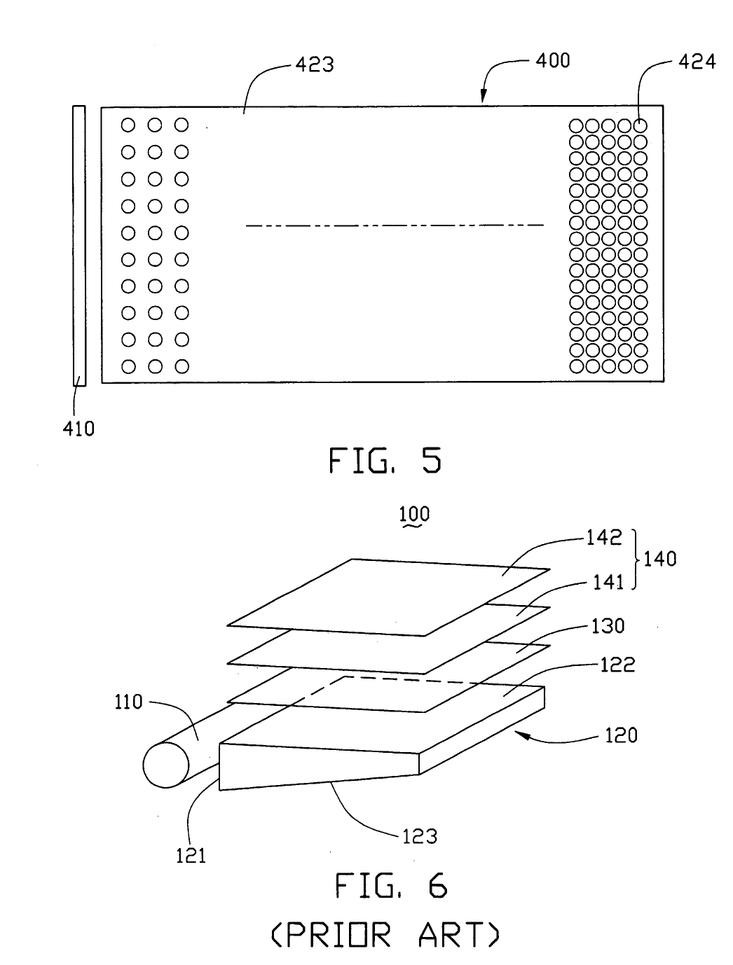

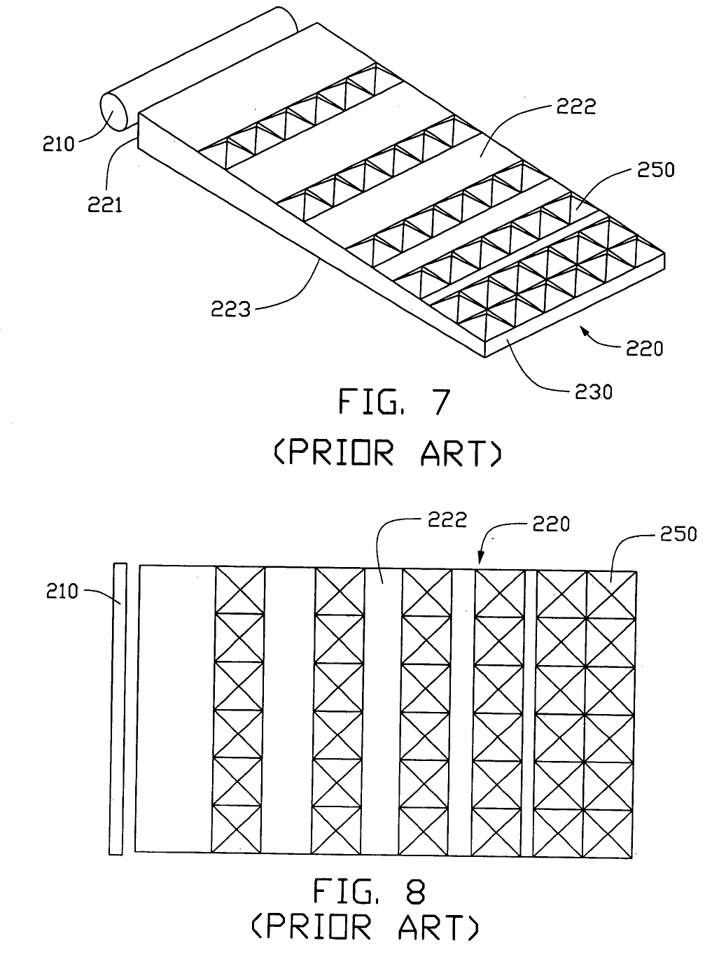

Referring to FIGS. 4 and 5, an alternative embodiment backlight system of the present invention comprises a light guide plate 400 and a light source 410 disposed at one side of the light guide plate 400.

The light guide plate 400 has a wedge shape and is made of a transparent material such as a synthetic resin or a glass. The light guide plate 400 comprises an incident surface 421 for receiving light from the light source 410, a bottom surface 423, and a light emitting surface 422 for emitting the light outwards, wherein the light emitting surface 422 has a contour in a shape of a plurality of prisms 450, each in a shape of a pyramid, disposed continuously on the light emitting surface 422. A plurality of diffusion dots 424 are formed on the bottom surface 423 by a screen-printing method. The diffusion dots 424 are distributed more densely on the bottom surface 423 as a distance away from the incident surface 421 increases, so they scatter the incident light from the incident surface 421 and uniformly transmit the light upwardly.

The light source 410 can be a cathode ray tube, such as a hot cathode ray tube or a cold cathode ray tube. A curved reflection plate (not shown) is provided to enclose the light source 410 to efficiently utilize the light beams emitted by the light source 410.

In operation, the light from the light source 410 is introduced into the light guide plate 400 through the incident surface 421, and then is totally reflected by the bottom surface 423 and uniformly scattered by the diffusion dots 424 to the light emitting surface 422. The more dense distribution of the diffusion dots 424 away from the incident surface helps to assure uniform emission through the light emitting surface 422.

The backlight system of the present invention has the following advantages. Firstly, a brightness of the outgoing light beams is enhanced by the pyramid-shaped prisms. Secondly, a distribution of the outgoing light beams is uniform all over the emitting surface because of the diffusion dots. Thirdly, the prisms are formed integrally with the light guide plate, and moreover, the prisms are distributed uniformly and continuously. Thus, the backlight system is easily manufactured and has a low cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A backlight system, comprising:
a light source; and
a light guide plate having an incident surface for receiving light from the light source, a bottom surface, and a light emitting surface for emitting out the light, wherein the light emitting surface has a contour in a shape of a plurality of prisms disposed continuously on the light emitting surface.

2. The backlight system as claimed in claimed 1, wherein a plurality of diffusion dots are disposed on the bottom surface of the light guide plate.

3. The backlight system as claimed in claimed 1, wherein the prisms are each in a shape of a pyramid.

4. The backlight system as claimed in claimed 1, wherein the light source is disposed at one side of the incident surface of the light guide plate.

5. The backlight system as claimed in claimed 1, wherein the light guide plate is in a shape of a rectangle.

6. The backlight system as claimed in claimed 1, wherein the light guide plate is in a shape of a wedge.

7. The backlight system as claimed in claimed 2, wherein the diffusion dots are more densely distributed on the bottom surface as a distance away from the incident surface increases.

8. The backlight system as claimed in claimed 2, wherein the diffusion dots are distributed evenly all over the bottom surface.

9. A light guide plate, comprising:
an incident surface for receiving light, a bottom surface, and a light emitting surface for emitting light, wherein the light emitting surface has a contour in a shape of a plurality of prisms disposed continuously on the light emitting surface.

10. The light guide plate as claimed in claimed 9, wherein a plurality of diffusion dots are disposed on the bottom surface.

11. The light guide plate as claimed in claimed 9, wherein the prisms are each in a shape of a pyramid.

12. The light guide plate as claimed in claim 9, wherein the light guide plate is in a shape of a rectangle

13. The light guide plate as claimed in claim 9, wherein the light guide plate is in a shape of a wedge.

14. The light guide plate as claimed in claim 10, wherein the diffusion dots are distributed more densely on the bottom surface as a distance away from the incident surface increases.

15. The light guide plate as claimed in claim 10, wherein the diffusion dots are distributed evenly all over the bottom surface.

16. A backlight system comprising:
a light source;
a light guide plate defining an incident surface facing the light source for receiving light from the light source;
a light emitting surface for emitting out the light;
a plurality of tapered prisms including respective vertex portions formed on the light emitting surface; and
a plurality of diffusion dots disposed on a bottom surface opposite to said emitting surface.

17. The backlight system as claimed in claim 16, wherein said diffusion dots are more densely distributed on the bottom surface as a distance from the incident surface increases.

18. The backlight system as claimed in claim 17, wherein said prisms are evenly distributed all over the emitting surface.
